(19) United States
(12) Patent Application Publication
(10) Pub. No.: US 2019/0152799 A1
(43) Pub. Date: May 23, 2019

(54) IMPROVED SITE DEVICE FOR RECYCLING WASHING WATER

(71) Applicant: EQUIPEMENT DE CHANTIERS ET LOCATIONS, CORDEMAIS (FR)

(72) Inventor: MARC LE FOLL, LA BAULE (FR)

(73) Assignee: EQUIPEMENT DE CHANTIERS ET LOCATIONS, CORDEMAIS (FR)

(21) Appl. No.: 15/540,776

(22) PCT Filed: Dec. 31, 2015
(86) PCT No.: PCT/EP2015/081475

§ 371 Date: Sep. 27, 2017

(30) Foreign Application Priority Data
Dec. 31, 2014 (FR) 14 63506

(51) Int. Cl. C02F 1/00; C02F 1/66

(52) U.S. Cl. CPC C02F 1/001; C02F 2103/44; C02F 1/66

(57) ABSTRACT

A tank includes a spill compartment including a flexible intermediate bulk container. The spill compartment is in hydraulic communication by overflow with a filtration and decantation compartment. The filtration and decantation compartment is in hydraulic communication with an intake compartment through a filtering partition. The intake compartment is in hydraulic communication with a discharge pipe through a hydraulic pump.

The invention relates to an improved worksite device for recycling washing water. The invention is more particularly but not exclusively designed for recycling washing water on worksites that use cement products. Such washing water is generated while cleaning tools and equipment for casting or preparing concrete and mortar, such as concrete skips, revolving drums or cement mixers.

Saving water and depolluting wastewater from worksites are increasingly becoming environmental concerns. Big infrastructure worksites involve the use of great quantities of equipment. Their maintenance requires frequent washing, which is generally carried out with high-pressure devices that consume large quantities of water. In addition to the environmental impact of discharging dirty water, the cost of consuming clean water also has an economic impact on the cost of the works. Many local authorities are thus requiring contractors to sign up to good practices aimed at reducing the environmental impact and promoting sustainable practices. As part of that, the contractor needs to not just put in place appropriate treatment resources, but must also be able to prove the effectiveness of such treatment and the enforcement of said practices throughout the period of the work.

Documents FR 2 669 930 and FR 2 669 997 disclose a transportable worksite device for decanting washing water dirtied by cement products and adjusting the pH of the water, in order to allow reuse for washing or to make it suitable for removal in environmentally compatible conditions.

These devices of the prior art are satisfactory, but are difficult to implement in practice, particularly as regards initial filtration and the recovery of coarse particles.

The invention aims to remedy the drawbacks of the prior art and therefore relates to a device for recycling water containing debris and particles, particularly derived from cement, comprising a first series of tanks, which series comprises:
a. a spill compartment adapted to contain a flexible intermediate bulk container, which spill compartment is in hydraulic communication by overflow with:
b. a filtration and decantation compartment, which compartment is in hydraulic communication through filtering means with:
c. an intake compartment, which compartment is in hydraulic communication with a discharge pipe through a first hydraulic pump.

Thus, the dirty water spills into a flexible intermediate bulk container or FIBC, better known as a “bulk bag”, and initial decantation is carried out in the spill compartment. Larger debris is easily recovered by removing the FIBC. Finer particles, which are not retained during the spill and initial decantation, are filtered by filtering means between the filtration and decantation compartment and the intake compartment, which provides a large potential volume during the spill and thus avoids the possibility of overflows if the filter is found to be clogged in the devices of the prior art, while providing filtration compatible with the working of the pump and keeping the device compact and transportable.

The invention can be implemented advantageously in the embodiments described below, which may be considered individually or in any technically operative combination.

In an advantageous embodiment, the device according to the invention comprises:
d. a tank, known as a duckboard tank, the opening of which, known as the spill surface, is closed by a duckboard and the bottom of which comprises a low point;
e. a lift pump adapted to lift the water spilling into the duckboard tank from the low point of said tank to the spill compartment.

That embodiment makes it possible to spill dirty water, contained for example in concrete skips, or wash parts directly on the duckboard of the duckboard tank, which tank is advantageously placed on ground level.

Advantageously, in this embodiment, the duckboard tank is adapted to support the weight of a vehicle on the spill surface. Thus, said tank is merely placed in the washing area, without needing any masonry work.

Advantageously, the duckboard tank comprises means to produce a washing jet directed towards surfaces of said tank. Thus, the debris and particles that remain, particularly on the walls of the tank, are carried away to the low point.

Advantageously, the means for producing the washing jet are supplied with water contained in the intake compartment. Thus, the water circulates in a closed circuit, which makes it possible to reduce the consumption of water on the worksite.

In an advantageous embodiment of the device according to the invention, the duckboard tank comprises a pre-filtration means between the spill surface and the bottom of said tank. That first pre-filtration means stops debris, clusters and coarser particles before they reach the lift pump of the duckboard tank, thus protecting said pump and speeding up the subsequent filtration steps.

Advantageously, the device according to the invention comprises, in this last embodiment, means to direct a washing jet on the pre-filtration means. Thus, washing that means particularly makes it possible to gradually dissolve clusters of cement products.

Advantageously, the pre-filtration means comprises a membrane made of geotextile complex. That membrane carries out the pre-filtration function, and also allows the easy removal of the largest debris.

Advantageously, the geotextile complex of the pre-filtration membrane is adapted to let through particles with a diameter below 500 μm.

In alternative embodiments, the pre-filtration membrane is placed directly on the duckboard or is stretched under the duckboard. The first alternative allows easier installation and recovery of said membrane. The second alternative avoids damaging the membrane, particularly when equipment is maneuvered on the spill surface.

Advantageously, the filtering means between the filtration and decantation compartment and the intake compartment of the device according to the invention forms a partition between the two compartments and comprises a structural frame supporting a filtering element. That arrangement makes it possible to maximize the filtration surface in relation to the overall dimensions of the tank. That advantageous arrangement is made possible by the fact that the filtering means is not directly subjected to the spill flow, which could damage the filter and is broken by the passage from the spill compartment to the filtration and decantation compartment through an overflow from said spill compartment.

Advantageously, said filtering means is removable, which allows easy replacement.

Advantageously, the tank according to the invention comprises:
f. filtration means between the intake compartment and the discharge pipe on the discharge of the first pump.

These filtration means, which advantageously comprise a cylindrical cartridge, allow additional filtration of the washing water to reduce the content of particles other than sedimentary particles or very fine particles.

Advantageously, the tank according to the invention comprises:
g. means for injecting CO₂ in the discharge pipe downstream from the filtration means.

Thus, the injection of CO₂ makes it possible to correct the pH of the recycled water.

Thus, advantageously, the tank according to the invention comprises:
h. a compartment insulated from the other compartments that is adapted to contain pressurized CO₂ cylinders.

The tank therefore makes up a compact and transportable assembly including all the elements necessary for implementing the recycling of washing water on the worksite.

In one embodiment, the tank according to the invention comprises the following in the spill compartment:
i. a large flexible intermediate bulk container the enclosure of which is made of fabric known as ventilated fabric, which is suitable for letting through particles with a diameter below 5 mm.

Such a container is very strong and only retains large particles, allowing the water from the overflowing sludge to flow rapidly to the filtration and decantation tank.

In another embodiment of the tank according to the invention, the flexible intermediate bulk container comprises non-woven filtering lining suitable for retaining particles with a diameter above 100 μm (100×10⁻⁶ m). Thus, said intermediate container takes part in first forced filtration of the overflowing water.

In an advantageous embodiment, the device according to the invention is connected and comprises a plurality of sensors for monitoring its operation.

Thus, advantageously, the device according to the invention comprises a sensor adapted to measure the flow of water in the discharge pipe of the pump of the first series of tanks. That sensor indicates the quantity of water treated.

Advantageously, the connected device comprises a sensor suitable for measuring the flow in the discharge pipe of the duckboard tank pump. Comparing that piece of information with the previous one makes it possible to measure the quantity of dirty water treated.

Advantageously, the device according to the invention comprises a sensor that measures the flow of injected CO₂. That information makes it possible to know the quantity of carbon dissolved in the treated water, and can particularly be used to establish the carbon footprint of the site.

The invention also relates to a method for monitoring the operation of an installation according to its connected embodiment, which method comprises the steps of:
i. transmitting the flow information from the different sensors to a computation center;
ii. aggregating the information thus received into consumption indicators;
iii. transmitting the indicators to a user terminal.

Thus, the user or the supervisor is informed in real time and remotely of the conditions of operation of the device for recycling soiled waste water.

The invention is described below in its preferred embodiments, which are not limitative in any way, and by reference to FIGS. 1 to 5, wherein:

FIG. 1 is a perspective cutaway exploded view of an exemplary embodiment of the first series of tanks of the device according to the invention;

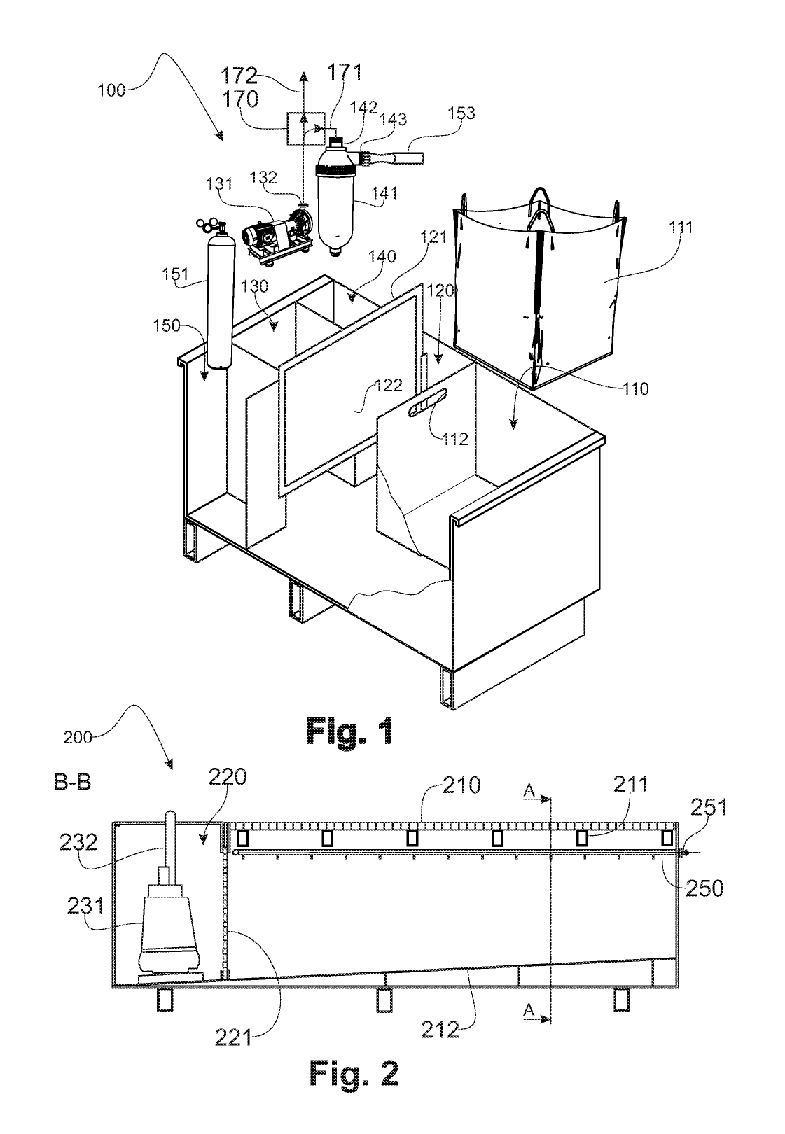

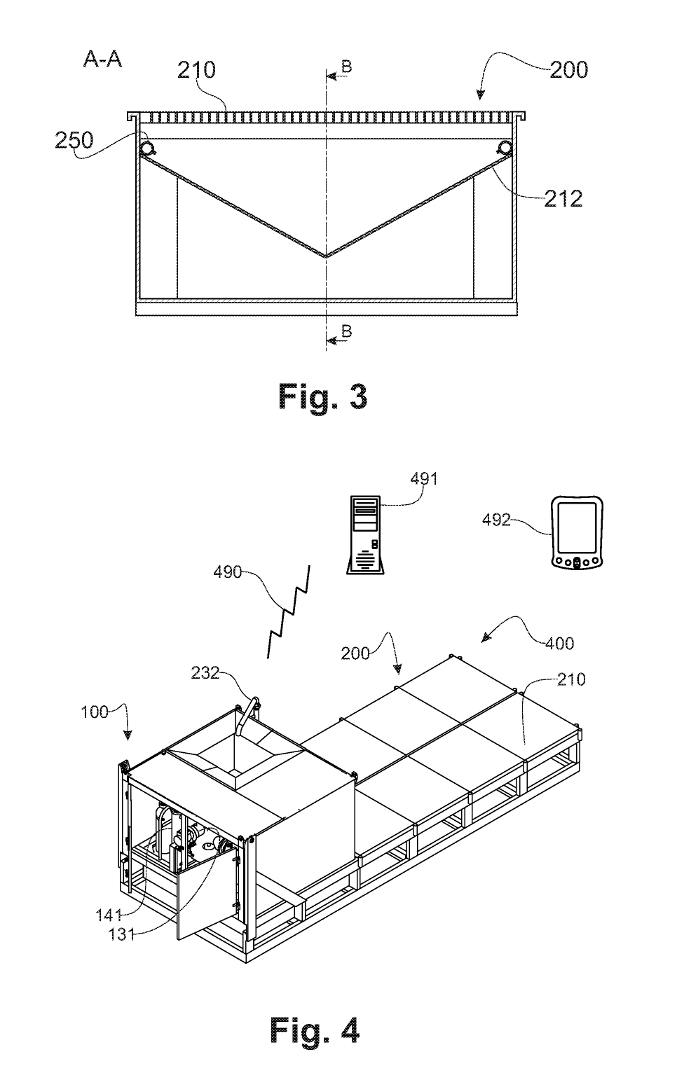

FIG. 2 is a profile view along a section B-B defined in FIG. 3, of an exemplary embodiment of the duckboard tank of the device according to the invention;

FIG. 3 is a front view along a section A-A defined in FIG. 2 of the duckboard tank of an exemplary embodiment of the device according to the invention;

FIG. 4 is a perspective view of an exemplary embodiment of the device according to the invention, combining two sets of tanks and connected to a computing center; and

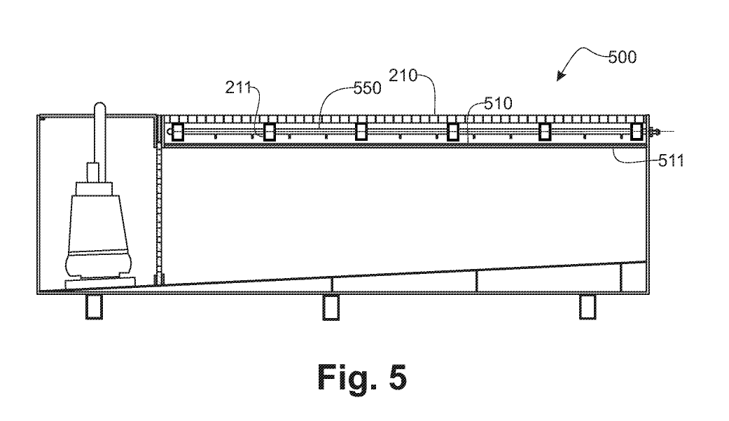

FIG. 5 is the same view as in FIG. 2 of an exemplary embodiment of the device according to the invention comprising a pre-filtration assembly at the spill surface.

The device according to the invention comprises two sets of tanks. A first series of tanks is designed for forced filtration and decantation and supplies depolluted water after pH correction. A second series of tanks is made up of a duckboard tank. Said duckboard tank is used for collecting the first washing or spill water, and depending on the embodiment of the tank, it allows pre-conditioning the water by eliminating debris, particles and coarser clusters. The two series of tanks can be used independently from each other, and depending on the embodiment, consist in two separate assemblies or an integrated assembly.

In FIG. 1 of an exemplary embodiment, the first series of tanks of the device according to the invention comprises a single tank (100) made in bent welded steel. A first compartment (110), known as the spill compartment, is suitable for receiving a FIBC (111). Said FIBC is for example made of woven polypropylene fabric ventilated to let through particles with a diameter above 5 mm. In an alternative embodiment, the FIBC (111) is lined over its inner surface with non-woven material that acts as a filter blocking particles with a diameter above 100 μm (100×10⁻⁶ m). Said spill compartment (110) comprises one or more overflow openings (112), so that when dirty water or sludge containing cement products spills into the FIBC (111) it only enters the filtration and decantation compartment after first decantation and possibly first filtration through the wall of the FIBC when it is lined on the inside with filtering fabric.

The filtration and decantation compartment (120) is in hydraulic communication with the spill compartment (110) through the overflow openings (112). That filtration and decantation compartment is the largest by volume in the tank. It is demarcated by a filtering partition (121) that is for example made up of a metal frame, fitted with filtering textile (122) adapted to stop particles with a diameter above 50 μm (50×10⁻⁶ m) or above 20 μm (20×10⁻⁶ m) if filtration has already been applied through the wall of the FIBC. Even if the filtering element (122) has been represented here, for clarity, in the form of flat fabric, other embodiments may be envisaged, particularly the use of pleated textiles intended to increase the filtering area. The filtering partition (121) is removable so as to allow the cleaning or replacement of the filtering element.

The third compartment (130) is known as the intake compartment. It is in hydraulic communication with the filtration and decantation compartment through the filtering partition (121) so that the water that arrives in that compartment has undergone decantation and filtration suitable for eliminating fine particles that could foul the pumps. A hydraulic pump (131) is installed on top of the compartment in order to pump the water in it. In this exemplary embodiment, the discharge (142) from the pump sends the water thus taken in via an appropriate pipe (not shown) to the inlet (142) of a cartridge filter (141). In exemplary embodiments, said cartridge filter comprises a cylindrical cartridge pleated into a star that provides filtration below 20 μm, a sand filter or a resin filter. That filtration assembly (141) is installed in a compartment (140) of the tank (100) of the first series of the device according to the invention, which compartment (140) is separated in a sealed manner from other compartments.

One compartment (150), separate from the others, is adapted to receive a cylinder (151) of carbon dioxide (CO₂). Said CO₂ is injected in the pump discharge flow, at the exit (143) from the filter (141), through a device (153) for injecting CO₂ comprising a venturi nozzle. The gas is injected at the neck of said venturi nozzle during discharge from the pump. That injection of CO₂ makes it possible to correct the pH of the water recycled in that way, so that it can be reused for washing or discharged in an environmentally compatible manner into the drains or spread.

Coarse sludge and solid residues are collected in the FIBC (111) and are easily removed.

In this exemplary embodiment of the device according to the invention, the tank (100) comprises, on one of its faces, a sealed connection and control unit (not shown), comprising means for connection to a source of electric current for pump operation, an on switch, protective fuses and buttons for adjusting the flow of CO₂. In an alternative embodiment (not shown), the compartments of the tank (100) in this exemplary embodiment make up separate tanks, particularly so as to facilitate their installation and the organization of the washing area using the device according to the invention on the worksite. Thus, in a non-limitative exemplary embodiment (not shown), the filtration and decantation compartment (120) is connected by a duct to a washing platform, so as to recover dirty water, where the washing water used on said platform is supplied by the first pump (131), and the spill compartment (110) is provided in a separate tank and is used for the spilling of water containing coarse particles, particularly first rinse water from a revolving drum truck or a concrete skip, which spills directly in said compartment. In this exemplary embodiment, said compartment (110) is connected hydraulically to the filtration and decantation compartment (120) by a duct.

In FIG. 2, in order to facilitate the spilling on the ground of the dirty water contained, for example, in concrete skips, revolving drum trucks, concrete units or from the washing of all dirty equipment, the device according to the invention comprises, in one exemplary embodiment, a tank (200) known as a duckboard tank. Said tank is a self-supporting structure suitable for supporting the weight of a vehicle. As a non-limitative example, said tank (200) has a length of about 6 meters, a width of about 2 meters and a depth of about 50 cm. That duckboard tank (200) is easily installed on the site in a slight excavation and makes up a washing and spilling area on its own, with no need to integrate it into masonry. Said duckboard tank comprises a spill surface (210) which is made up for example of a galvanized steel duckboard supported by transverse beams (211). It comprises a sloping bottom (212) that guides liquid to a low point. In this exemplary embodiment, the tank (200) comprises a collection compartment (220) located at said low point and including a lift pump (231) adapted to take in liquid or sludge comprising solid particles, for example a centrifugal pump. Said pump (231) comprises a discharge pipe (232), which discharges the liquid taken in from the collection compartment (220) into the spill compartment of the first series of tanks of the device according to the invention. In one exemplary embodiment, the collection compartment (220) is separated from the remainder of the duckboard tank by a perforated wall (221) adapted to stop the largest debris. As a non-limitative example, said wall comprises perforations with a diameter of 10 mm. Advantageously, said perforated wall (221) is removable in order to make it easier to clean the duckboard tank.

In one exemplary embodiment, the walls of the duckboard tank (200) are rinsed with a jet of water by means of a rinsing ramp (250), which ramp is, in one exemplary embodiment, supplied with water taken from the intake compartment of the first series of tanks of the device according to the invention.

Returning to FIG. 1, the device according to the invention comprises for that purpose a distributing valve (170), which valve is manual or pilot operated, so as to distribute the flow of filtered and decanted liquid taken in by the first pump (131) between a first outlet (171) directed to the cartridge filter (141), which flow is, where applicable, treated to lower its pH and a second exit (172) connected directly to the inlet (251) of the rinsing ramp of the duckboard tank. The water treated to lower its pH to a value ranging from 6.5 to 8.5 is directed, for example, to one or more washing guns, for example a washing gun on the washing platform, and a washing gun on the ground washing area. In one embodiment, a booster means is installed on the circuit connecting the outlet of the cartridge filter and a washing gun so as to allow high-pressure washing.

The pumping sequences of the two pumps (131, 231) of the device according to the invention and the flows turned towards the washing guns and the rinsing ramp are, in one embodiment, controlled by a programmable logic controller contained in the control unit.

In FIG. 3 of an exemplary embodiment, the bottom (212) of the duckboard tank comprises a double slope in order to channel the material overflowing into the duckboard tank towards the collection compartment. The rinsing ramp (250) is applied on the slopes of the bottom (212) so as to push debris towards the center.

In FIG. 4 of an exemplary embodiment, the duckboard tank (200) and the first series (100) of tanks are integrated into a single device (400). In this exemplary embodiment, said series comprises flow sensors (not shown) adapted to measure the flow of water in the discharge pipe (232) of the lift pump of the duckboard tank (200), the flow of water passing through the discharge pipe of the pump (131) of the first series of tanks, and the flow of CO₂ injected in the retreated water. Said sensors send their information to the PLC that controls the device according to the invention, which PLC comprises a cellular link (490) that allows it to exchange data with a computation center (491). During that exchange, the PLC also sends information about its model, for example a commercial reference, and geolocation indications. The computation center generates indicators relating to the consumption and retreatment of water on the site. These indicators are sent to the terminals (492) of users, who are continually informed of the operation of the device. The cellular connection is for example provided by ultra-narrow band radio (UNB) in the 866 MHz or 902 MHz frequency, for example using the SIGFOX® protocol. Thus, the user can at all times know the quantity of water used, the quantity of water recycled, the quantity of CO₂ dissolved in the treated water. These data can be archived and allow the user to prepare periodic consumption statements or provide evidence of retreatment to the relevant authorities. In alternative embodiments, other sensors are installed and, for example, allow the measurement of the flow of water through the cartridge filter (141) or the temperature of the water.

In FIG. 5 of another exemplary embodiment, the duckboard tank (500) comprises pre-filtration means (510, 511). In this exemplary embodiment, geotextile (510) is stretched on a mesh (511) under the cross members (211) supporting the duckboard (210). A washing system (550) is placed above the membrane. Said membrane is for example configured to let through relatively fine particles, for example with a diameter below 1 mm or below 0.5 mm, but these values are not strictly limitative. Thus, larger debris are retained or at least slowed down by the duckboard (210). Smaller debris and more particularly clusters of cement products with sand or gravel are stopped by the membrane (510). The membrane is regularly watered by the washing system (550) and said clusters are loosened and only fine particles and laitance are sent to the bottom of the tank. In an alternative embodiment, the geotextile membrane is placed on the duckboard. Thus, debris and coarse particles are eliminated from time to time by catching them in the membrane.

The description above and the exemplary embodiments show that the invention achieves the objectives sought, in particular it makes it possible to rapidly install a system for washing, recycling and treating water on a work site. The device according to the invention comprises all the treatment means, which are pre-installed, and can be easily connected on the work site and easily removed. The use of an FIBC for the spill is economical and can, where applicable, allow the reuse of containers used for bringing other materials to the site. The device according to the invention is connected and allows a supervisor to know the working and performance of the site remotely, and archive the performance for subsequent analysis.

1-23. (canceled)

24. A device to recycle water containing debris and particles, comprising a first series of tanks comprising:
a spill compartment comprising a flexible intermediate bulk container;
a filtration and decantation compartment, the spill compartment is in hydraulic communication by overflow with the filtration and decantation compartment;
an intake compartment in hydraulic communication with a first discharge pipe through a first hydraulic pump, the filtration and decantation compartment is in hydraulic communication with the intake compartment through a filter; and
wherein the debris and particles are derived from cement.

25. The device according to claim 24, further comprising a duckboard tank comprising a spill surface as an opening, which is closed by a duckboard, and a bottom comprising a low point; and a lift pump configured to lift water spilling into the duckboard tank from the low point to the spill compartment through a second discharge pipe.

26. The device according to claim 25, wherein the duckboard tank is configured to support a weight of a vehicle on the spill surface.

27. The device according to claim 25, wherein the duckboard tank comprises a rinsing ramp to produce a washing jet directed towards surfaces of the duckboard tank.

28. The device according to claim 27, wherein the rinsing ramp is supplied with water contained in the intake compartment.

29. The device according to claim 27, wherein the duckboard tank comprises a pre-filter between the spill surface and the bottom of the duckboard tank.

30. The device according to claim 29, further comprising a washing system to direct the washing jet on the filter.

31. The device according to claim 29, wherein the pre-filter comprises a membrane made of geotextile complex.

32. The device according to claim 31, wherein the membrane is placed on the duckboard.

33. The device according to claim 31, wherein the membrane is stretched under the duckboard.

34. The device according to claim 31, wherein the geotextile complex of the membrane is configured to pass through particles with a diameter below 500 μm.

35. The device according to claim 24, wherein the filter forms a partition between the filtration and decantation compartment and the intake compartment, and comprises a structural frame supporting a filtering element.

36. The device according to claim 35, wherein the partition is removable.

37. The device according to claim 24, further comprising a filtration unit between the intake compartment and the first discharge pipe on a discharge of the first hydraulic pump.

38. The device according to claim 37, wherein the filtration unit comprises a cartridge filter.

39. The device according to claim 37, further comprising an injector to inject CO₂ in the first discharge pipe downstream from the filtration unit.

40. The device according to claim 39, further comprising a gas compartment, insulated from other compartments, configured to house a cylinder of pressurized CO₂.

41. The device according to claim 24, wherein an enclosure of the flexible intermediate bulk container is made of a ventilated fabric configured to pass through particles with a diameter below 5 mm.

42. The device according to claim 41, wherein the flexible intermediate bulk container comprises a non-woven filtering lining configured to retain particles with a diameter above 100 μm.

43. The device according to claim 24, further comprising a first sensor configured to measure a flow of water in the first discharge pipe of the first hydraulic pump of the first series of tanks.

44. The device according to claim 43, further comprising a duckboard tank comprising a spill surface as an opening, which is closed by a duckboard, and a bottom comprising a low point; a lift pump configured to lift water spilling into the duckboard tank from the low point to the spill compartment through a second discharge pipe; and a second sensor configured to measure a flow of water in the second discharge pipe of the lift pump.

45. The device according to claim 44, further comprising an injector to inject CO₂ in the first discharge pipe downstream from the filtration unit; and comprising a third sensor configured to measure a flow of injected CO₂.

46. A method for monitoring an operation of the device according to claim 45, comprising the steps of:
transmitting a flow information from the first, second and third sensors to a computation center;
aggregating the flow information received into consumption indicators; and
transmitting the consumption indicators to a user terminal.
